(19) United States
(12) Patent Application Publication
(10) Pub. No.: US 2011/0186756 A1
(43) Pub. Date: Aug. 4, 2011

(54) METHOD OF FABRICATING A SINGLE PHOTON SOURCE

(75) Inventors: Steven Trpkovski, Victoria (AU); Steven Prawer, Victoria (AU); David Allan Simpson, Victoria (AU); Eric Ampem-Lassen, Victoria (AU); Brant Cameron Gibson, Victoria (AU)

(73) Assignee: THE UNIVERSITY OF MELBOURNE, Melbourne (AU)

(21) Appl. No.: 12/919,205

(22) PCT Filed: Feb. 25, 2009
(86) PCT No.: PCT/AU09/00215

§ 371 Date: Mar. 30, 2011

(30) Foreign Application Priority Data
Feb. 25, 2008 (AU) 2008900884

(51) Int. Cl. G02F 1/39; B07C 5/34; G01N 21/00; B25J 11/00

(52) U.S. Cl. 250/493.1; 209/546; 414/800

(57) ABSTRACT

The present disclosure provides a method of fabricating a single photon source. The method comprises the steps of providing a substrate with a visual feature and providing a plurality of particles positioned on the substrate. The particles are positioned in the proximity of the visual feature and include a particle that is arranged for single photon emission in response to a suitable excitation. The method also includes characterising photon emission from the particles to identify the single photon emission and thereby identifying an approximate location of the particle arranged for single photon emission relative to the visual feature. Further, the method includes imaging the visual feature and an area in the proximity of the visual feature and thereby imaging the particle arranged for single photon emission. In addition, the method includes moving the particle arranged for single photon emission to a predetermined position comprising coupling a suitable device to the particle and lifting the particle using the suitable device.

### FIELD OF THE INVENTION

The present invention broadly relates to a method of fabricating a photon source.

### BACKGROUND OF THE INVENTION

Optical fibres provide avenues for transmission of large quantities of data at high speed. However, conventional optical data transmission systems typically only provide limited security and unauthorised access to information associated with the transmitted data may be a problem.

Quantum communication systems are optical data transmission systems that enable secure transmission of the data. Quantum communication relies on the principals of quantum mechanics and requires transmission of single photons in contrast to large number of photons that are transmitted using conventional optical data transmission systems. If the data is transmitted in the form of pulses of single photons, it can be verified if the data has been accessed and/or changed in any way by an unauthorised party.

Current quantum communication systems rely on attenuated laser light to provide the single photons. However, such systems guarantee single photons with a reliability of only 85%. True sources of single photons are available at present only in laboratories and comprise very large and complicated set-ups. For example, sources of single photons may comprise a large number of diamond particles which have so called “colour centres” and from which single photons are emitted upon excitation. Each diamond particle may comprise a number of such colour centres and the identification of a diamond particle having only one colour centre and exciting only that one diamond particle within the plurality of other diamond particles is challenging.

There is a need for technological advancement.

### SUMMARY OF THE INVENTION

The present invention provides in a first aspect a method of fabricating a single photon source, the method comprising the steps of:
providing a substrate with a visual feature;
providing a plurality of particles positioned on the substrate, the particles being positioned in the proximity of the visual feature and including a particle that is arranged for single photon emission in response to a suitable excitation;
characterising photon emission from the particles to identify the single photon emission and thereby identifying an approximate location of the particle arranged for single photon emission relative to the visual feature;
imaging the visual feature and an area in the proximity of the visual feature and thereby imaging the particle arranged for single photon emission; and
moving the particle arranged for single photon emission to a predetermined position comprising coupling a suitable device to the particle and lifting the particle using the suitable device.

Throughout this specification the term “single photon emission” is used for emission of photons in a manner so that only one photon is emitted at a time and the term “single photon source” is used for a source of photons that is arranged for single photon emission. For example, the single photon source may emit in use a sequence or pulse of single (individual) photons.

Throughout this specification the term “visual feature” is used for a feature that is visible with the naked eye and/or with the aid of a microscope, such as an optical microscope or an electron microscope.

The method may comprise marking the substrate to provide the visual feature. The method typically comprises the step of recording a position of the particle arranged for single photon emission relative to the visual feature.

The step of characterising photon emission from the particles to identify single photon emission typically comprises detecting fluorescence radiation from the particles and analysing the fluorescence radiation for single photon emission using an anti-correlation measurement, which may use a Hanbury Brown-Twiss Interferometer setup.

The method characterises an optical response from the particle that is arranged for single photon emission and further identifies an approximate location of the particle relative to the visual feature. However, the particle that is arranged for single photon emission typically is a very small particle having a diameter smaller than 500 nm, smaller than 200 nm or even smaller than 80 nm. In one specific embodiment the particle arranged for emission of single photons has a diameter of the order of 40-150 nm and consequently the particle typically is too small for imaging and identifying the precise location using optical microscopy.

The step of imaging the visual feature and an area in the proximity of the visual feature typically comprises electron microscopy, such as secondary electron microscopy, which typically has sufficient spatial resolution for resolving an image of the particle arranged for single photon emission.

The step of moving the particle arranged for emission of single photons to a predetermined location typically comprises moving only that particle to the predetermined location, which typically is remote from the locations of other ones of the particles. Consequently, optical excitation of only that particle, and thereby single photon emission, is facilitated. Embodiments of the method in accordance with the first aspect of the present invention enable fabrication of single photon sources having well-defined optical properties.

The step of moving the particle to a predetermined position typically comprises imaging the particle and at least a portion of the suitable device during movement. Coupling the particle to the suitable device may comprise forming an electro-static coupling.

For example, the suitable device may be a probe, such as a probe formed from an electrically insolating which may be silica. In one specific example the probe is an elongated member and has an end-portion that is tapered over a length of 1-5 mm from a thickness of approximately 50-200 urn to a tip with a diameter of approximately 20-100 nm, typically of the order of 50 nm

The predetermined position may be on the substrate. In this case the predetermined position is typically located at a location remote from other ones of the particles.

In one specific embodiment the predetermined position is remote from the substrate. For example, the predetermined position may be on an end-face of an optical fibre. The method may comprise the step of providing the optical fibre with a recess at the end-face of the optical fibre. The predetermined position typically is within the recess, which typically is formed at a core region of the optical fibre.

The method may also comprise forming the recess in the optical fibre using a suitable etching procedure. For example, the recess may be formed by etching an end-face of the optical fibre. The optical fibre typically comprises a core region that has a higher dopant concentration than a core-surrounding region. In this case the etching procedure is selected so that the etching procedure will predominantly etch the core region. Consequently, the etching will form a recess at the core region and, if the particle arranged for a single photon emission is positioned within the recess, the particle is positioned at a substantially central location of the end-face.

The particles typically comprise a material having a diamond structure and typically comprise a diamond material such as single or polycrystalline diamond material. The diamond material typically comprises at least one colour centre.

Throughout this specification, the term “colour centre” is used for any optically active atomic, molecular or vacancy centre from which photons may be emitted including atomic, molecular or vacancy centres which are arranged for a decay of an excited stated via emission of a single photons.

The or each colour centre typically comprises an impurity or impurities in the diamond material. For example, the or each impurity may be a nitrogen atom positioned adjacent a vacancy such that a nitrogen-vacancy (N-V) colour centre is formed. The or each impurity may also be a nickel-related colour centre commonly referred to as a “NE8” colour centre. Such an N-V colour typically is arranged to emit single photons having a wavelength in the vicinity of 637 nm upon suitable excitation.

The particle arranged for single photon emission typically comprises one colour centre.

The substrate may be a wafer, such as a silicon wafer. The step of providing the substrate on which the particles are positioned typically comprises positioning the particles on the substrate. Positioning the particles on the substrate may comprise exposing the substrate to a liquid in which the particles are suspended and depositing the particles on the substrate by evaporating or otherwise removing or the liquid.

The present invention provides in a second aspect a single photon source fabricated by the method in accordance with the first aspect of the present invention.

The present invention provides in a third aspect a method of moving a particle to a predetermined location, the method comprising the steps of:

providing a particle on a substrate, the particle having a diameter of the order of 10-500 nm; moving a tip of a probe towards the particle so that the tip couples to that particle, the tip of the probe having a diameter of the order of 10-500 nm; and moving the probe with the particle so that the particle is lifted off the substrate and moved to the predetermined location.

The probe and typically also the particle comprises an electrically insulating material. For example, the probe may comprise silica. Coupling the tip of the probe to the particle may comprise forming an electro-static coupling.

In one specific example the probe is an elongated member and has an end-portion that is tapered over a length of 1-5 mm from a thickness of approximately 50-200 μm to a tip which may have a diameter of the order of 20-100 nm, typically of the order of 50 nm.

The invention will be more fully understood from the following description of specific embodiments of the invention. The description is provided with reference to the accompanying drawings.

### BRIEF DESCRIPTION OF THE DRAWINGS

FIG. 1 shows a flow chart illustrating a method of fabricating a single photon source in accordance with a specific embodiment of the present invention;

FIG. 2 (a) shows a schematic illustration of visual features and (b) a substrate in which the visual features are inscribed and on which particles are positioned in accordance with a specific embodiment of the present invention;

FIG. 3 (a) shows an optical fluorescence radiation image of an area of the substrate with the particles and (b) a secondary electron microscopy micrograph of the same area that is shown in FIG. 3 (a);

FIGS. 4 (a) and 4(b) show higher magnification electron microscopy micrographs of the substrate with particles and also show a probe for moving particles in accordance with a specific embodiment of the present invention;

FIG. 5 shows an etched end-face of an optical fibre and the probe for moving particles in accordance with a specific embodiment of the present invention; and

FIG. 6 shows a depth profile of the surface across the end-face of the optical fibre as shown in FIG. 5.

### DETAILED DESCRIPTION OF SPECIFIC EMBODIMENTS

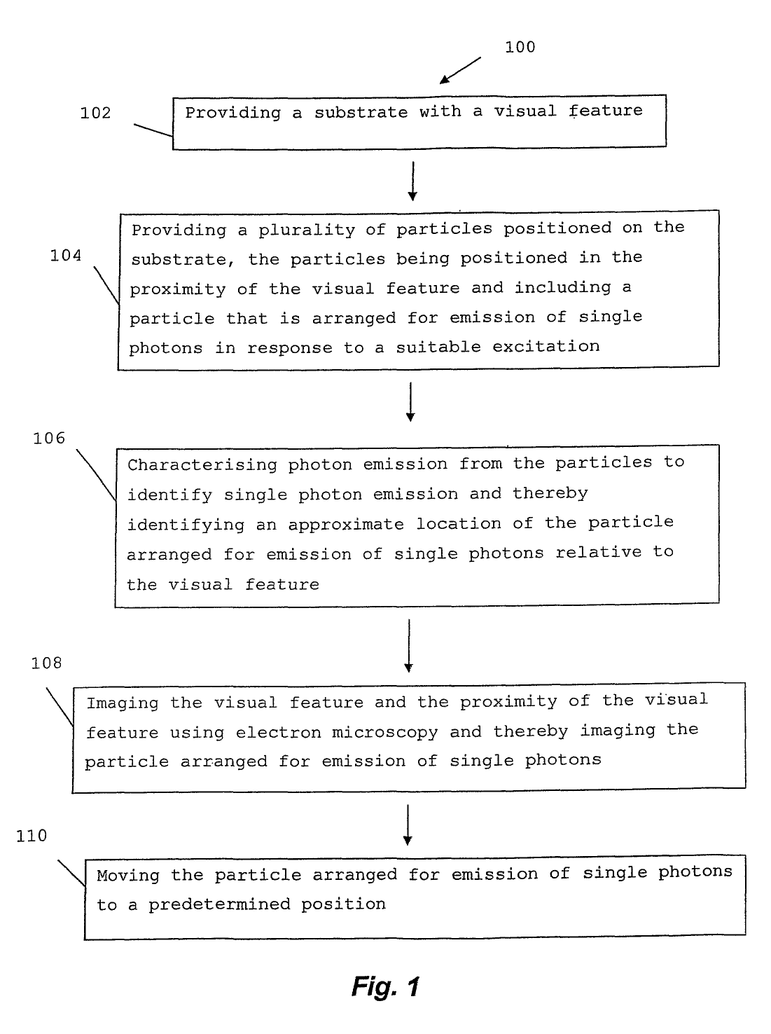

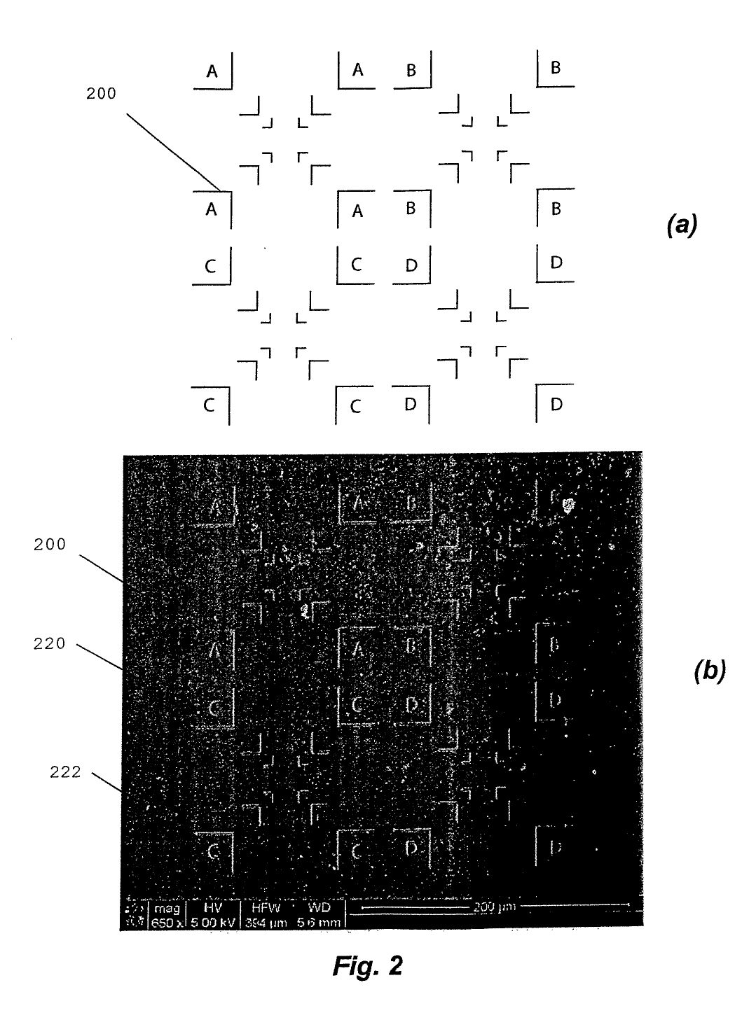

Referring initially to FIGS. 1 and 2, a method of fabricating a single photon source in accordance with a specific embodiment of the present invention is now described. The method 100 comprises step 102 of providing a substrate with a visual feature. For example, the substrate may be a wafer such as a silicon wafer or may be provided in any other suitable form. The visual feature is in this embodiment provided in the form of a pattern that is inscribed into the surface of the wafer using a focused ion beam. FIG. 2 (a) shows visual features 200 which are inscribed in the surface of substrate 220 shown in FIG. 2 (b).

The method 100 also includes step 104 of providing a plurality of particles positioned on the substrate. The particles 222, shown in FIG. 2 (b), are positions in the proximity of the visual features 200 and include a particle that is arranged for emission of single photons in response to a suitable excitation.

In this embodiment step 104 also comprises cleaning the substrate using acetone, methanol and deionised water prior to depositing the particles on the substrate 220. The particles, in this example diamond particles, are initially suspended in a solution (approximately 0.0076 g in 25 ml of methanol). The diamond powder includes in this example particles having a diameter in the range of 0.5-5.0 um. The solution with the diamond particles is exposed to an ultrasonic treatment for a few hours, which further breaks down the diamond particles to an average size of the order of 10-500 nm and results in increased particle size uniformity.

The substrate is then exposed to the solution and the ultrasonic treatment is continued for approximately 30 minutes. A stream of nitrogen is used to facilitate evaporation of the methanol and thereby depositing the diamond particles on the substrate 220.

The diamond material has impurities in the matrix, such as nitrogen atoms positioned adjacent a vacancy (N-V colour centre). The N-V colour centre typically is arranged for emission of radiation having a wavelength in the vicinity of 637 nm. A diamond particle arranged for single photon emission typically comprises one NV colour centre.

However, the majority of the diamond particles typically comprise more than one NV colour centre and it will be described below how the particle(s) having one colour centre can be identified.

Method 100 also includes step 106 of characterising photon emission from the particles to identify single photon emission and thereby identify an approximate location of the particle arranged for emission of the single photons relative to the visual features 200. The step 106 selects those particles which only contain one colour centre and consequently can function as a true source of single photons.

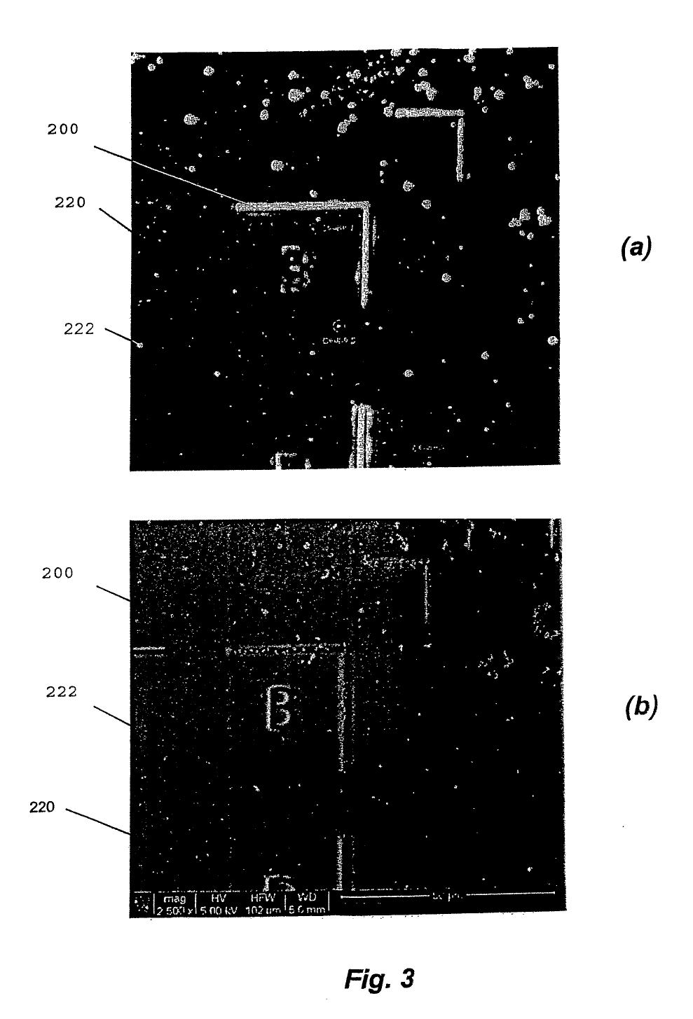

FIG. 3 (a) shows fluorescent radiation emitted from the substrate 220 and the diamond particles 222 positioned on the substrate 220. The fluorescent radiation is captured for individual ones of the particles 222 and the captured fluorescent radiation is checked for single photon emission using a Hanbury Brown-Twiss interferometer set-up for anti-correlation measurements. For further details concerning anti-correlation measurements using the Hanbury Brown-Twiss interferometer setup reference is being made to R. Hanbury Brown and R. Q. Twiss, “Correlation between photons in two coherent beams of light.” Nature 177, 27-29 (1956). The position of an identified particle that emits single photons is then recorded relative to one or more visual features 200.

The method 100 also includes step 108 of imaging a visual features and an area in the proximity of the visual features using secondary electron microscopy whereby the particle arranged for emission of single photons is imaged. The surface of the substrate is initially coated with a thin layer of carbon to enable electrical conductivity and thereby enable imaging using scanning electron microscopy without charging. FIG. 3 (b) shows an electron micrograph of the same area for which an optical image is shown in FIG. 3 (a) (both at a magnification of 2,500 times). The diamond particles typically have a size of the order of 40-500 nm. Consequently, the diamond particles are too small to be imaged using an optical microscope. While FIG. 3 (a) shows fluorescent radiation emitted from the particles, FIG. 3 (a) does not show actual images of such small diamond particles. As the approximate location of the particle which emits single photons has been recorded, it is now possible to identify which particle imaged on FIG. 3 (b) is the particle that emits in use the single photons.

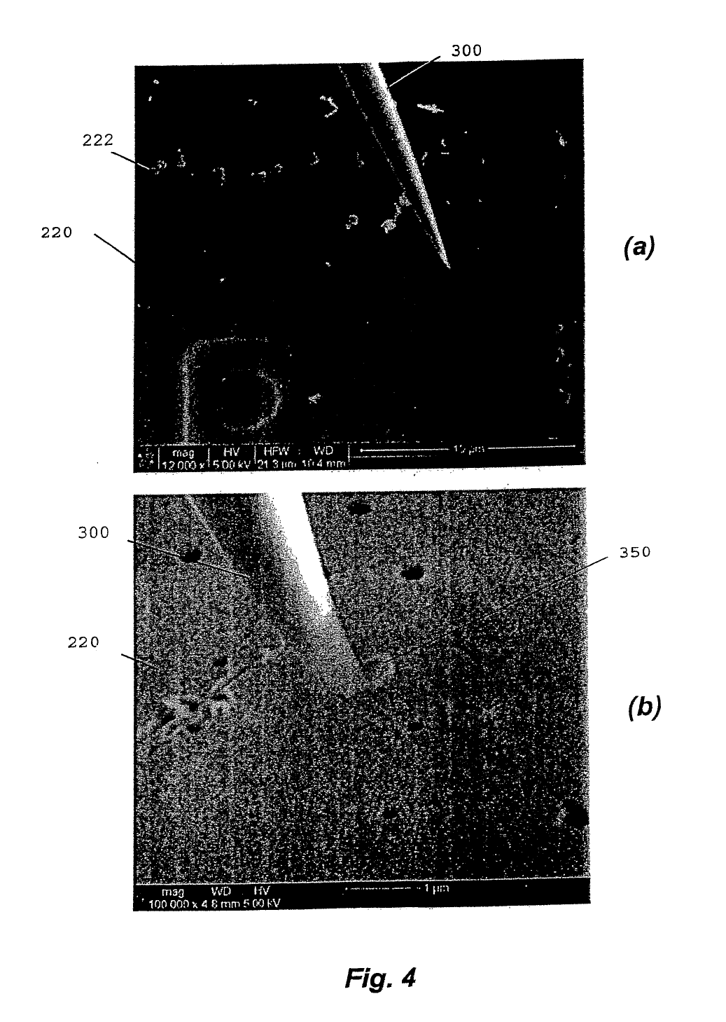

FIGS. 4 (a) and 4 (b) show higher resolution secondary electron microscopy micrographs of areas that are also shown in FIGS. 2. FIG. 4 (a) shows an area of the substrate 220 at a magnification of 12,000 times and FIG. 4 (b) shows an area of the substrate 220 at an magnification of 100,000 times.

Further, FIGS. 4 (a) and (b) also show a probe 300 for moving the selected particle that is arranged for single source photon emission. In the embodiment for the probe 300 is fabricated from an elongated rod of silica having a diameter of the order of 125 μm. The probe 300 has an end-portion that is, over a length of 1.75 mm, tapered to a tip having a diameter of the order of 50 nm.

The inventors have observed that a particle, such as a diamond particle having a suitable size, can be lifted with the tip of the probe 300 by moving the tip relative to the particle so that the tip touches the particle and then lifting the probe 300. It is possible that electro-static forces between the tip of the probe 300 (composed of insulating silica) and the (insulating) diamond particle result in sufficient forces so that the particle are lifted from the surface of the substrate 220.

It is to be appreciated that in variations of the described embodiment the probe 300 may have differing dimensions and may be composed of other suitable materials. Further, the probe 300 may be used to move suitable particles other than diamond particles.

The method 100 also includes step 110 of moving the particle arranged for emission of single photons to a predetermined position. FIG. 4 (b) shows the particle 350 that is arranged for single photon emission. The tip of the probe 300 is moved towards the particle 350 and the particle 350 is then lifted off the surface of the substrate and moved to the predetermined position.

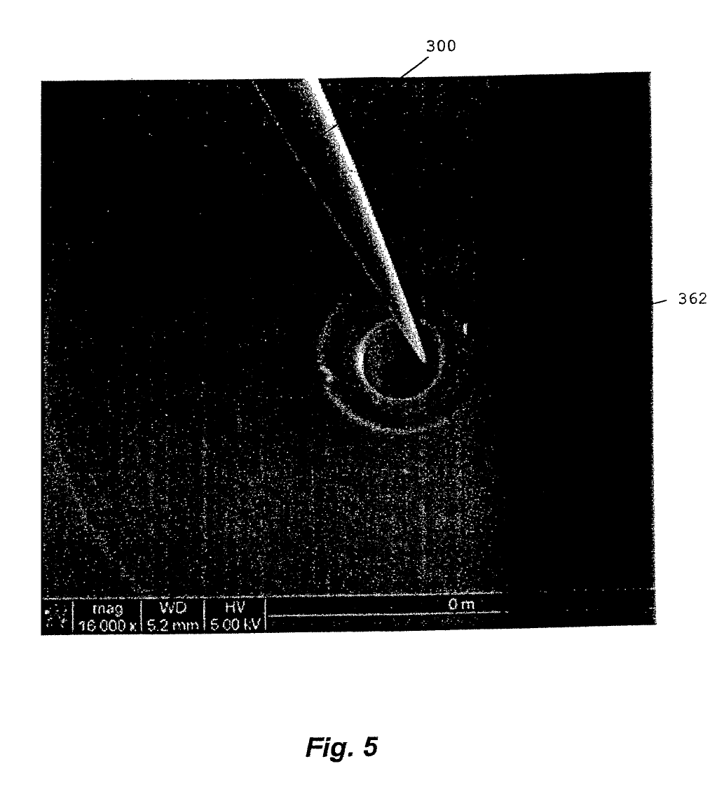

FIG. 5 shows an end-face 360 of an etched optical fibre. For preparation of the end-face 360 of the optical fibre a short length of an optical fibre with a predetermined dopant profile was cleaved and the end-face of the optical fibre was then exposed to a solution of 50% HF and 50% water for 30 seconds, which results in predominant etching of areas having higher dopant concentrations. Other combinations of HF and water can be used, however, the etch rate of the doped silica and undoped silica regions will vary accordingly. The profiled end-face 360 is then cleaned and dried.

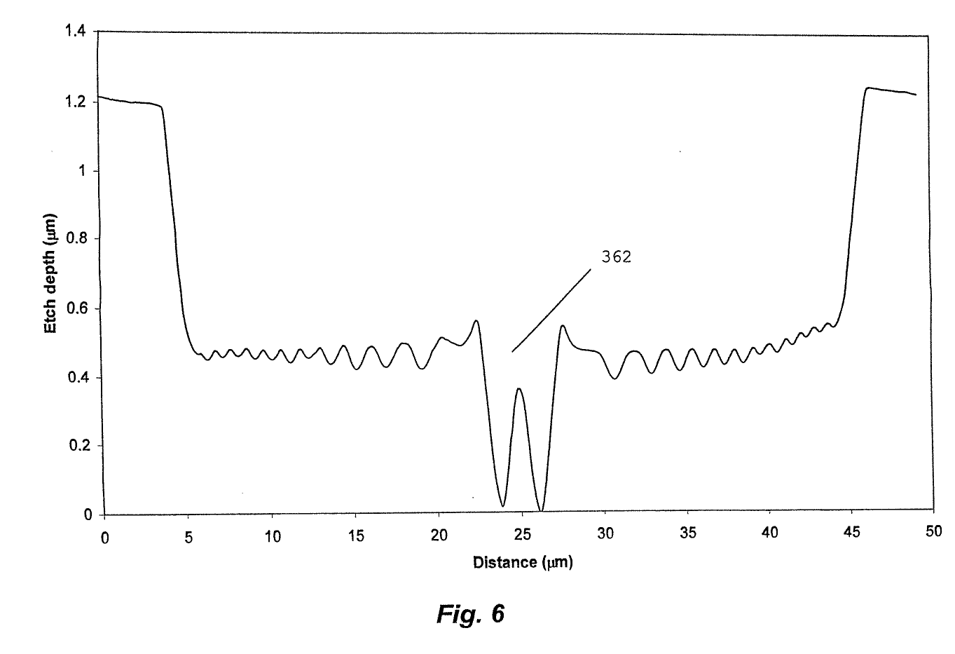

A person skilled in the art will appreciate that optical fibres typically have regions of differing dopant concentrations. For example, a core region of an optical fibre typically has a higher dopant concentration than core-surrounding regions. The end-face 360 of the optical fibre is shown in FIG. 5. The optical fibre has a dopant concentration that varies across the radius of the optical fibre within the core-surrounding region so that the etching forms concentric indentations. FIG. 6 shows a depth profile of the etched end-face 360 of the optical fibre.

In this embodiment the predetermined position, to which the particle is moved, is within a recess 362 formed in the core region by the etching process. The step 110 of moving the particle comprises in this embodiment moving the probe 300 with the particle 350 towards the recess 362 of the etched end-face 360 and positioning the particle 350 within the recess 362. In this embodiment the particle is “scraped off” at wall portions of the recess 362. The positioning of the particle 350 and the moving of the probe 300 typically is monitored using secondary electron microscopy. The concentric indentations on the end-face 360 of the optical fibre function as an aid for locating the recess 362. The particle 350 arranged for single photon emission is in this embodiment positioned in the proximity of the centre of the optical fibre.

The particle 350 arranged for single photon emission is isolated from any other diamond particles that also have colour centres and single photon emission may be initiated by exposing the particle 350, or a larger region also including areas of the optical fibre surrounding the single photon source, to a suitable optical radiation.

Although the invention has been described with reference to particular examples, it will be appreciated by those skilled in the art that the invention may be embodied in many other forms. For example, predetermined position may not necessarily be on an end-face of an optical fibre and the particle arranged for single photon emission may be moved using any other suitable means. Further, it is to be appreciated by a person skilled in the art that the particles may not necessarily comprise a diamond material and may alternatively comprise an alternative material that is arranged so that at least one of the particles in use emits single photon.

1-21. (canceled)

22. A method of fabricating a single photon source, the method comprising the steps of:
providing a substrate with a visual feature;
providing a plurality of particles positioned on the substrate, the particles being positioned in the proximity of the visual feature and including a particle that is arranged for single photon emission in response to a suitable excitation;
characterising photon emission from the particles to identify the single photon emission and thereby identifying an approximate location of the particle arranged for single photon emission relative to the visual feature;
imaging the visual feature and an area in the proximity of the visual feature and thereby imaging the particle arranged for single photon emission; and
moving the particle arranged for single photon emission to a predetermined position comprising coupling a suitable device to the particle and lifting the particle using the suitable device.

23. The method of claim 22 comprising marking the substrate to provide the visual feature.

24. The method of claim 22 wherein the step of characterising photon emission comprises the step of recording a position of the particle arranged for single photon emission relative to the visual feature.

25. The method of claim 22 wherein the step of imaging the visual feature and an area in the proximity of the visual feature comprises electron microscopy.

26. The method of claim 22 wherein the step of moving the particle arranged for emission of single photons to a predetermined location comprises moving only that particle to the predetermined location.

27. The method of claim 22 wherein the suitable device for lifting the particle is a probe, the probe comprising an elongated member and having an end-portion that is tapered over a length of 1-5 mm from a thickness of approximately 50-200 μm to a tip with a diameter of approximately 20-100 nm.

28. The method of claim 27 wherein the probe is formed from an electrically insulating material.

29. The method of claim 22 wherein the predetermined position is remote from the substrate.

30. The method of claim 29 wherein the predetermined position is on an end-face of an optical fibre.

31. The method of claim 30 comprising the step of providing the optical fibre with a recess at the end-face of the optical fibre.

32. The method of claim 31 wherein the recess is formed at a core region of the optical fibre and wherein the predetermined position is within the recess.

33. The method of claim 32 comprising forming the recess in the optical fibre using a suitable etching procedure.

34. The method of claim 33 wherein the optical fibre comprises a core region that has a higher dopant concentration than a core-surrounding region and the recess is formed by etching an end-face of the optical fibre.

35. The method of claim 22 wherein the particles comprise a material having a diamond structure and comprise at least one colour centre.

36. The method of claim 22 wherein the step of providing the substrate on which the particles are positioned comprises positioning the particles on the substrate.

37. The method of claim 36 wherein positioning the particles on the substrate comprises exposing the substrate to a liquid in which the particles are suspended.

38. A single photon source fabricated by the method of claims 22.

39. A method of moving a particle to a predetermined location, the method comprising the steps of:
providing a particle on a substrate, the particle having a diameter of the order of 10-500 nm;
moving a tip of a probe towards the particle so that the tip couples to that particle, the tip of the probe having a diameter of the order of 10-500 nm; and
moving the probe with the particle so that the particle is lifted off the substrate and moved to the predetermined location.

40. The method of claim 39 wherein the probe comprises an electrically insulating material.

41. The method of claim 40 wherein the particles comprise an electrically insulating material.

42. The method of claim 39 wherein the probe is an elongated member and has an end-portion that is tapered over a length of 1-5 mm from a thickness of approximately 50-200 μm to a tip which may have a diameter of the order of 20-100 nm.
